(19) United States
(12) Patent Application Publication
(10) Pub. No.: US 2018/0284530 A1
(43) Pub. Date: Oct. 4, 2018

(54) LIQUID CRYSTAL DISPLAY DEVICE

(71) Applicant: Shenzhen China Star Optoelectronics Technology Co., Ltd., Shenzhen City, (CN)

(72) Inventors: Lixuan Chen, Shenzhen City (CN); Hsiaohsien Chen, Shenzhen City (CN); Yungjui Lee, Shenzhen City (CN)

(21) Appl. No.: 15/539,696

(22) PCT Filed: Apr. 19, 2017
(86) PCT No.: PCT/CN2017/081026

§ 371 Date: Jun. 26, 2017

(30) Foreign Application Priority Data
Mar. 28, 2017 (CN) 201710194156.1

(51) Int. Cl. G02F 1/1335; G02F 1/1333

(52) U.S. Cl. CPC G02F 1/133514; G02F 1/133528; G02F 1/133345; G02F 2001/136222; G02F 2001/133614; G02F 2001/133562; G02F 2001/133567; G02F 1/1336

(57) ABSTRACT

The present invention provides a liquid crystal display device, which includes a liquid crystal panel including a first substrate and a second substrate respectively arranged at upper and lower sides and opposite to each other, a liquid crystal layer, and a third substrate that is arranged on one side of the first substrate that is distant from the liquid crystal layer or one side of the second substrate that is distant from the liquid crystal layer, wherein the first substrate comprises a first backing plate and an upper polarizer arranged on the first backing plate; the second substrate comprises a second backing plate and a lower polarizer arranged on the second backing plate; and the third substrate comprises a third backing plate and a quantum dot color filter plate arranged on the third backing plate. The present invention is structured to have the quantum dot color filter plate arranged on the third backing plate that is different from the backing plates that carry the upper and lower polarizers thereon so that the quantum dots do not alter the state of polarization of light in the interior of the panel and no complicated polarizer internalization operation is necessary, while ensuring preservation of the advantages of the quantum dot color filter plate, providing the liquid crystal display device with a wider color gamut and higher brightness, and the manufacturing process is made simple.

### BACKGROUND OF THE INVENTION

### 1. Field of the Invention

The present invention relates to the field of display technology, and more particular to a liquid crystal display device.

### 2. The Related Arts

The development of science and technology and the progress of human society make people increasingly rely on exchange and transmission of information. As a major carrier, as well as a physical basis, for exchange and transmission of information, a display device is now a hot spot and highland that scientists who devote themselves to study and research in the field of photoelectronics must capture.

Quantum dots (QDs) are generally extremely tiny organic nanometer crystals that are not visually observable and are mostly nanometer materials having a three-dimensional configuration made of elements of II-VI groups or III-V groups. Due to the quantum confinement effect, transportation of electrons and holes in the interior is constrained and a continuous energy band is converted into a discrete energy level structure. Once receiving excitation of external energy, such as light or electricity, the quantum dots give off a color light and the color of the light is determined by the constituent materials, size and shape of the quantum dots. Different sizes of quantum dots provide different extents of quantum confinement for electrons and holes so that the discrete energy level structures are different. Generally, the smaller the particles are, the longer the wavelength that will be absorbed would be; and the larger the particles are, the shorter the wavelength that will be absorbed would be. Regular quantum dots absorb blue light that has a relatively short wavelength and will be excited to give off color light of a longer wavelength. Such a characteristic allows the quantum dots to change the color of light emitting from a light source.

An advantage of quantum dots is that through adjustment of the size of the quantum dots, it is possible to realize emissive wavelength covering both infrared band and entire visible light band, and the band of the emissive light band can be made narrow and shows high degree of color saturation. The quantum dots have a high quantum dot conversion efficiency and the material shows stable property; the manufacturing method is simple, allowing for preparation from solutions and ensuring rich resources.

Heretofore, a liquid crystal display (LCD) provides colors by means of a color filter (CF) layer. A conventional color filter layer is formed by subjecting color resist materials to a series of photolithographic operations. The color resist materials are made by dissolving and distributing a polymer, a monomer, a photo initiator, and a pigment in a solvent. Recently, manufacturers, such as Samsung Electronics Co., Ltd., proposed an idea of using a quantum dot color filter (QDCF) made of quantum dot materials to replace the conventional color filter plate.

Making a QDCF with QD nanometer materials requires solvents and ligands used in combination and certain progress has been made in this field. For example, some patent documents have been available concerning fabrication of color filter plates with quantum dots. However, the quantum dot color filter plates proposed in these patent documents are arranged inside liquid crystal cells. Since the principles based on which colors are generated are different between the quantum dots and the commonly used pigments of the color filter plates, where light emission of the quantum dots is achieved through excitation by light to cause a change of the energy band structure of the quantum dot so as to emit a specific wavelength of light, if the common way that a polarizer (POL) is attached to an outside surface of a glass backing a liquid crystal display is still adopted, then backlight that passes through a lower polarizer generates linear polarization light polarized at a specific direction and when the linear polarization light is applied to excite quantum dots, the polarized light in the specific direction would change the polarization condition thereof (such as de-polarization or variation of polarization direction). This makes a light path and brightness become uncontrollable.

To prevent the above problems, a polarizer structure must be added between the QDCF and a liquid crystal layer. As shown in FIG. 1, which is a schematic view illustrating a structure of a conventional liquid crystal display device, the liquid crystal display device comprises a liquid crystal panel 10 and a backlight module 50 arranged under the liquid crystal panel 10. The liquid crystal panel 10 comprises a first substrate 20 and a second structure 30 that are respectively arranged at upper and lower sides and opposite to each other and a liquid crystal layer 40 arranged between the first substrate 20 and the second substrate 30. The first substrate 20 comprises a first backing plate 21 and an optic film 22, a quantum dot color filter layer 23, a planarization layer 24, an upper polarizer 25, and an electrode layer 26 that are arranged, in sequence, on a side of the first backing plate 21 that is adjacent to the liquid crystal layer 40; and the second substrate 30 comprises a second backing plate 31, a thin-film transistor (TFT) layer 32 arranged on a side of the second backing plate 31 that is adjacent to the liquid crystal layer 40, and a lower polarizer 33 arranged on a side of the second backing plate 31 that is distant from the liquid crystal layer 40, wherein due to high sensitivity of the QD materials to moisture and oxygen, the planarization layer 24 is provided between the upper polarizer 25 and the quantum dot color filter layer 23 to provide protection to the quantum dot color filter layer 23.

However, for the liquid crystal display device shown in FIG. 1, an important issue is the internalization of the polarizers. Internalization of polarizers can be achieved with several solutions, one example being a solution in which a nanometer grating polarizer is internally arranged. However, internally arranged polarizers of this kind provides contrast that is lower than polarization achieved with the conventional PVA polarizer and requires a more complicated process of manufacturing and expensive equipment for fabrication of large sizes.

In view of the above problems, it is desired to provide a novel structure for liquid crystal display devices, which requires no complicated polarizer internalization process, while still ensuring the advantages of QDCF.

### SUMMARY OF THE INVENTION

An objective of the present invention is to provide a liquid crystal display device, in which a quantum dot color filter plate is arranged on a third backing plate other than the backing plates on which upper and lower polarizers are mounted so as to avoid a complicated polarizer internalization process, making the manufacturing process simple.

To achieve the above objective, the present invention provides a liquid crystal display device, which comprises a liquid crystal panel and a backlight module arranged under the liquid crystal panel;

wherein the liquid crystal panel comprises a first substrate and a second substrate respectively arranged on upper and lower sides and opposite to each other, a liquid crystal layer arranged between the first substrate and the second substrate, and a third substrate arranged on a side of the first substrate that is distant from the liquid crystal layer or a side of the second substrate that is distant from the liquid crystal layer;

the first substrate comprises a first backing plate and an upper polarizer arranged on the first backing plate;

the second substrate comprises a second backing plate and a lower polarizer arranged on the second backing plate; and

the third substrate comprises a third backing plate and a quantum dot color filter plate arranged on the third backing plate.

The third substrate further comprises an optic film layer arranged on the quantum dot color filter plate and providing a function of wave filtration.

The third substrate is arranged on the side of the first substrate that is distant from the liquid crystal layer;

the third substrate further comprises an encapsulation layer arranged on the optic film layer; and

the third backing plate, the quantum dot color filter plate, the optic film layer, and the encapsulation layer of the third substrate are arranged, in sequence, on the side of the first substrate that is distant from the liquid crystal layer.

The third substrate arranged on the side of the second substrate that is distant from the liquid crystal layer; and

the optic film layer, the quantum dot color filter plate, and the third backing plate of the third substrate are arranged, in sequence, on the side of the second substrate that is distant from the liquid crystal layer.

The third substrate is attached to the side of the first substrate that is distant from the liquid crystal layer by coating adhesive on a circumferential edge or an entire surface of the first substrate; or, alternatively,

the third substrate is attached to the side of the second substrate that is distant from the liquid crystal layer by coating adhesive on a circumferential edge or an entire surface of the second substrate.

The upper polarizer is arranged on a side of the first backing plate that is distant from or adjacent to the liquid crystal layer; and

the lower polarizer is arranged on a side of the second backing plate that is distant from or adjacent to the liquid crystal layer.

The quantum dot color filter plate comprises a pixel separation layer and a red pixel unit, a green pixel unit, and a blue pixel unit that are separated from each other by the pixel separation layer.

The backlight module comprises a blue fluorescent light source and the red pixel unit and the green pixel unit are respectively formed of a red quantum dot ink material and a green quantum dot ink material through inkjet printing and the blue pixel unit is formed of a material comprising a transparent organic material.

The optic film layer is formed through patterning and functions to remove blue fluorescent light that emits from the backlight module and is not converted after transmission through the red pixel unit and the green pixel unit.

The first backing plate, the second backing plate, and the third backing plate each comprise a glass plate, a polyimide (PI) plate, or a polyethylene terephthalate (PET) plate.

The present invention also provides a liquid crystal display device, which comprises a liquid crystal panel and a backlight module arranged under the liquid crystal panel;

wherein the liquid crystal panel comprises a first substrate and a second substrate respectively arranged on upper and lower sides and opposite to each other, a liquid crystal layer arranged between the first substrate and the second substrate, and a third substrate arranged on a side of the first substrate that is distant from the liquid crystal layer or a side of the second substrate that is distant from the liquid crystal layer;

the first substrate comprises a first backing plate and an upper polarizer arranged on the first backing plate;

the second substrate comprises a second backing plate and a lower polarizer arranged on the second backing plate; and

the third substrate comprises a third backing plate and a quantum dot color filter plate arranged on the third backing plate;

wherein the third substrate further comprises an optic film layer arranged on the quantum dot color filter plate and providing a function of wave filtration; and

wherein the first backing plate, the second backing plate, and the third backing plate each comprise a glass plate, a polyimide (PI) plate, or a polyethylene terephthalate (PET) plate.

The efficacy of the present invention is that the present invention provides a liquid crystal display device, which comprises a liquid crystal panel comprising a first substrate and a second substrate respectively arranged at upper and lower sides and opposite to each other, a liquid crystal layer, and a third substrate that is arranged on one side of the first substrate that is distant from the liquid crystal layer or one side of the second substrate that is distant from the liquid crystal layer, wherein the first substrate comprises a first backing plate and an upper polarizer arranged on the first backing plate; the second substrate comprises a second backing plate and a lower polarizer arranged on the second backing plate; and the third substrate comprises a third backing plate and a quantum dot color filter plate arranged on the third backing plate. The present invention is structured to have the quantum dot color filter plate arranged on the third backing plate that is different from the backing plates that carry the upper and lower polarizers thereon so that the quantum dots do not alter the state of polarization of light in the interior of the panel and no complicated polarizer internalization operation is necessary, while ensuring preservation of the advantages of the quantum dot color filter plate, providing the liquid crystal display device with a wider color gamut and higher brightness, and the manufacturing process is made simple.

### BRIEF DESCRIPTION OF THE DRAWINGS

The technical solution, as well as other beneficial advantages, of the present invention will become apparent from the following detailed description of embodiments of the present invention, with reference to the attached drawings.

In the drawings:

FIG. 1 is a schematic view showing a structure of a conventional liquid crystal display device;

FIG. 2 is a schematic view showing a structure of a first embodiment of a liquid crystal display device according to the present invention;

FIG. 3 is a schematic view showing a structure of a quantum dot color filter plate included in the liquid crystal display device according to the present invention; and

FIG. 4 is a schematic view showing a structure of a second embodiment of the liquid crystal display device according to the present invention.

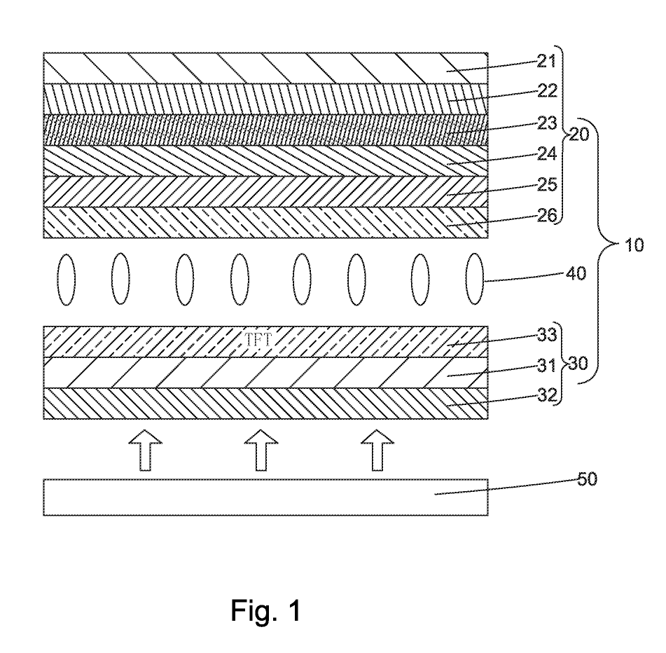

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

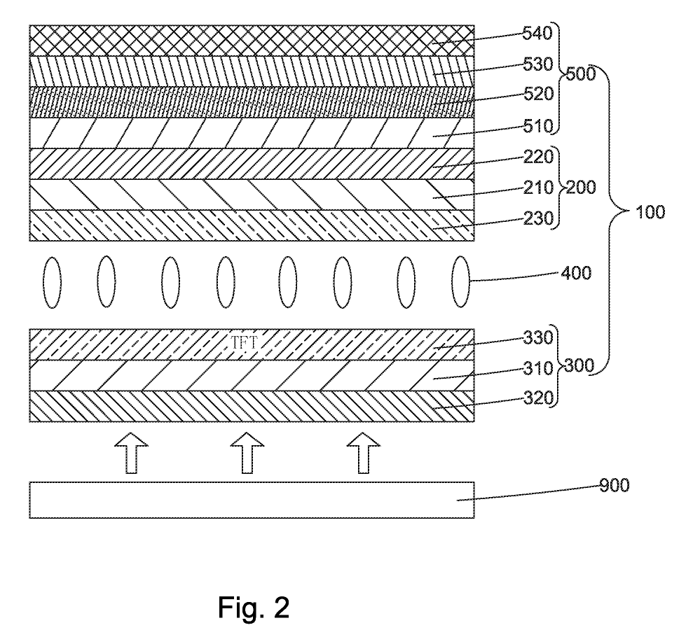

Referring to FIG. 2, which is a schematic view showing a structure of a first embodiment of a liquid crystal display device according to the present invention, in the instant embodiment, the liquid crystal display device comprises a liquid crystal panel 100 and a backlight module 900 arranged under the liquid crystal panel 100.

The liquid crystal panel 100 comprises a first substrate 200 and a second substrate 300 respectively arranged at upper and lower sides and opposite to each other, a liquid crystal layer 400 arranged between the first substrate 200 and the second substrate 300, and a third substrate 500 arranged on one side of the first substrate 200 that is distant from the liquid crystal layer 400.

The first substrate 200 comprises a first backing plate 210 and an upper polarizer 220 arranged on the first backing plate 210.

The second substrate 300 comprises a second backing plate 310 and a lower polarizer 320 arranged on the second backing plate 310.

The third substrate 500 comprises a third backing plate 510 and a quantum dot color filter plate 520 arranged on the third backing plate 510.

Specifically, the third substrate 500 further comprises an optic film layer 530 arranged on the quantum dot color filter plate 520 and provides a function of wave filtration for removing excessive backlighting that emits from the backlight module 900 and is not converted by quantum dots contained in the quantum dot color filter plate 520.

Specifically, in the instant embodiment, the third substrate 500 further comprises an encapsulation layer 540 arranged on the optic film layer 530.

The third backing plate 510, the quantum dot color filter plate 520, the optic film layer 530, and the encapsulation layer 540 of the third substrate 500 are arranged, in sequence, on the side of the first substrate 200 that is distant from the liquid crystal layer 400.

Specifically, the third substrate 500 is attached to the side of the first substrate 200 that is distant from the liquid crystal layer 400 by adhesive that is coated on a circumferential edge or an entire surface of the first substrate 200.

Specifically, the upper polarizer 220 can be an internally arranged polarization plate or can alternatively be an externally arranged polarization plate, and may be arranged on a side of the first backing plate 210 that is distant from the liquid crystal layer 400 or arranged on a side of the first backing plate 210 that is adjacent to the liquid crystal layer 400. Preferably, the upper polarizer 220 is an externally arranged polarization plate, which is arranged on the side of the first backing plate 210 that is distant from the liquid crystal layer 400. In the instant embodiment, the upper polarizer 220 is arranged on the side of the first backing plate 210 that is distant from the liquid crystal layer 400.

Specifically, the lower polarizer 320 may similarly be an internally arranged polarization plate or, alternatively, an externally arranged polarization plate, and thus, can be arranged on one side of the second backing plate 310 that is distant from the liquid crystal layer 400 or can alternatively be arranged on one side of the second backing plate 310 that is adjacent to the liquid crystal layer 400. Preferably, the lower polarizer 320 is an externally arranged polarization plate, which is arranged on the side of the second backing plate 310 that is distant from the liquid crystal layer 400. In the instant embodiment, the lower polarizer 320 is arranged on the side of the second backing plate 310 that is distant from the liquid crystal layer 400.

Specifically, the first substrate 200 further comprises a function layer 230 arranged on one side of the first backing plate 210 that is adjacent to the liquid crystal layer 400 for electrode and/or alignment. The second substrate 300 further comprises a thin-film transistor (TFT) layer 330 arranged on one side of the second backing plate 310 that is adjacent to the liquid crystal layer 400.

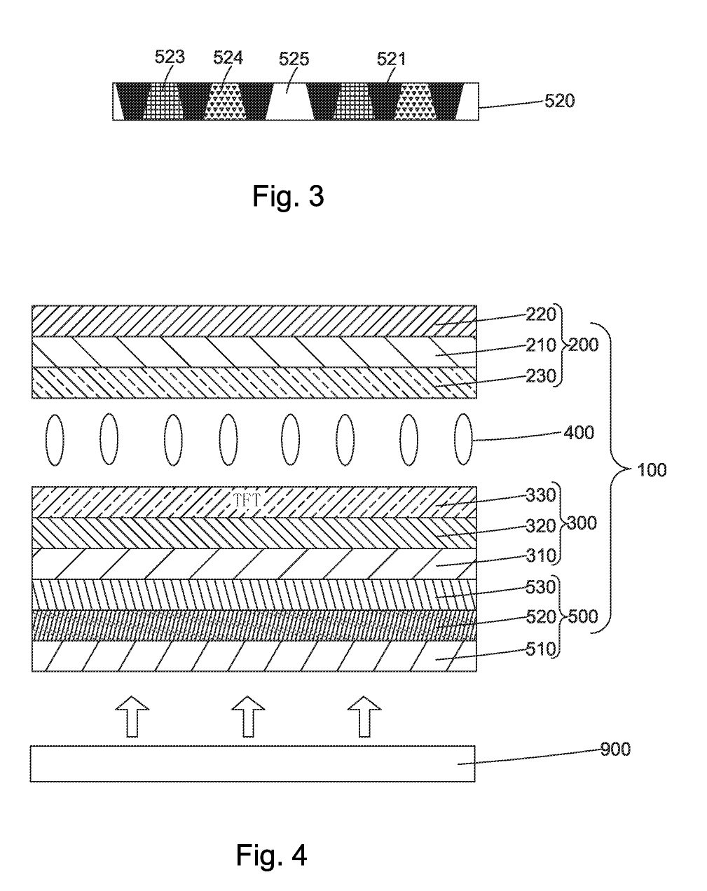

Specifically, as shown in FIG. 3, the quantum dot color filter plate 520 comprises a pixel separation layer 521 and a red pixel unit 523, a green pixel unit 524, and a blue pixel unit 525 that are separated from each other by the pixel separation layer 521.

Specifically, the backlight module 900 comprises a blue fluorescent light source. The red pixel unit 523 and the green pixel unit 524 are respectively formed of a red quantum dot ink material and green quantum dot ink material each applied through an inkjet printing operation. Since blue light carries higher energy, which may excite a red quantum dot (that is a quantum dot that emits red light) and a green quantum dot (that is a quantum dot that emits green light) to respectively generate red light and green light, the backlight module 900 that generates blue fluorescent light may serve as a backlighting source such that blue light is supplied by the backlight module 900 itself, and thus, a blue pixel unit 525 may be formed by filling a transparent organic material.

Specifically, the optic film layer 530 is formed through a patterning operation and is provided for removing the blue fluorescent light that emits from the backlight module 900 but is not yet converted after transmission through the red pixel unit 523 and the green pixel unit 524.

Specifically, the first backing plate 210, the second backing plate 310, and the third backing plate 510 are each a glass plate or a flexible plate such as a polyimide (PI) plate or a polyethylene terephthalate (PET) plate.

The liquid crystal display device of the present invention is structured to arrange the quantum dot color filter plate 520 on a third backing plate 510 that is different from first and second backing plates 210, 310 that respectively carry upper and lower polarizers 220, 320 thereon such that the quantum dots contained in the quantum dot color filter plate 520 do not alter the state of polarization of light in the interior of a panel and no complicated polarizer internalization operation is necessary, while ensuring preservation of the advantages of the quantum dot color filter plate 520, providing the liquid crystal display device with a wider color gamut and higher brightness, and the manufacturing process is made simple.

Referring to FIG. 4, which is a schematic view showing a structure of a second embodiment of the liquid crystal display device according to the present invention, compared to the first embodiment described above, the second embodiment is structured such that the third substrate 500 is arranged on the side of the second substrate 300 that is distant from the liquid crystal layer 400.

Specifically, the optic film layer 530, the quantum dot color filter plate 520, and the third backing plate 510 of the third substrate 500 are arranged, in sequence, on the side of the second substrate 300 that is distant from the liquid crystal layer 400. Further, in the instant embodiment, the lower polarizer 320 is an internally arranged polarization plate, where the lower polarizer 320 is arranged on the side of the second backing plate 310 that is adjacent to the liquid crystal layer 400 and the TFT layer 330 is arranged on a side of the lower polarizer 320 that is adjacent to the liquid crystal layer 400. The remaining features are similar to those of the first embodiment described above and repeated description will be omitted herein.

In summary, the present invention provides a liquid crystal display device, which comprises a liquid crystal panel comprising a first substrate and a second substrate respectively arranged at upper and lower sides and opposite to each other, a liquid crystal layer, and a third substrate that is arranged on one side of the first substrate that is distant from the liquid crystal layer or one side of the second substrate that is distant from the liquid crystal layer, wherein the first substrate comprises a first backing plate and an upper polarizer arranged on the first backing plate; the second substrate comprises a second backing plate and a lower polarizer arranged on the second backing plate; and the third substrate comprises a third backing plate and a quantum dot color filter plate arranged on the third backing plate. The present invention is structured to have the quantum dot color filter plate arranged on the third backing plate that is different from the backing plates that carry the upper and lower polarizers thereon so that the quantum dots do not alter the state of polarization of light in the interior of the panel and no complicated polarizer internalization operation is necessary, while ensuring preservation of the advantages of the quantum dot color filter plate, providing the liquid crystal display device with a wider color gamut and higher brightness, and the manufacturing process is made simple.

Based on the description given above, those having ordinary skills in the art may easily contemplate various changes and modifications of the technical solution and the technical ideas of the present invention. All these changes and modifications are considered belonging to the protection scope of the present invention as defined in the appended claims.

What is claimed is:

1. A liquid crystal display device, comprising a liquid crystal panel and a backlight module arranged under the liquid crystal panel;
wherein the liquid crystal panel comprises a first substrate and a second substrate respectively arranged on upper and lower sides and opposite to each other, a liquid crystal layer arranged between the first substrate and the second substrate, and a third substrate arranged on a side of the first substrate that is distant from the liquid crystal layer or a side of the second substrate that is distant from the liquid crystal layer;
the first substrate comprises a first backing plate and an upper polarizer arranged on the first backing plate;
the second substrate comprises a second backing plate and a lower polarizer arranged on the second backing plate; and
the third substrate comprises a third backing plate and a quantum dot color filter plate arranged on the third backing plate.

2. The liquid crystal display device as claimed in claim 1, wherein the third substrate further comprises an optic film layer arranged on the quantum dot color filter plate and providing a function of wave filtration.

3. The liquid crystal display device as claimed in claim 2, wherein the third substrate is arranged on the side of the first substrate that is distant from the liquid crystal layer;
the third substrate further comprises an encapsulation layer arranged on the optic film layer; and
the third backing plate, the quantum dot color filter plate, the optic film layer, and the encapsulation layer of the third substrate are arranged, in sequence, on the side of the first substrate that is distant from the liquid crystal layer.

4. The liquid crystal display device as claimed in claim 2, wherein the third substrate arranged on the side of the second substrate that is distant from the liquid crystal layer; and
the optic film layer, the quantum dot color filter plate, and the third backing plate of the third substrate are arranged, in sequence, on the side of the second substrate that is distant from the liquid crystal layer.

5. The liquid crystal display device as claimed in claim 1, wherein the third substrate is attached to the side of the first substrate that is distant from the liquid crystal layer by coating adhesive on a circumferential edge or an entire surface of the first substrate; or, alternatively,
the third substrate is attached to the side of the second substrate that is distant from the liquid crystal layer by coating adhesive on a circumferential edge or an entire surface of the second substrate.

6. The liquid crystal display device as claimed in claim 1, wherein the upper polarizer is arranged on a side of the first backing plate that is distant from or adjacent to the liquid crystal layer; and
the lower polarizer is arranged on a side of the second backing plate that is distant from or adjacent to the liquid crystal layer.

7. The liquid crystal display device as claimed in claim 2, wherein the quantum dot color filter plate comprises a pixel separation layer and a red pixel unit, a green pixel unit, and a blue pixel unit that are separated from each other by the pixel separation layer.

8. The liquid crystal display device as claimed in claim 7, wherein the backlight module comprises a blue fluorescent light source and the red pixel unit and the green pixel unit are respectively formed of a red quantum dot ink material and a green quantum dot ink material through inkjet printing and the blue pixel unit is formed of a material comprising a transparent organic material.

9. The liquid crystal display device as claimed in claim 8, wherein the optic film layer is formed through patterning and functions to remove blue fluorescent light that emits from the backlight module and is not converted after transmission through the red pixel unit and the green pixel unit.

10. The liquid crystal display device as claimed in claim 1, wherein the first backing plate, the second backing plate, and the third backing plate each comprise a glass plate, a polyimide (PI) plate, or a polyethylene terephthalate (PET) plate.

11. A liquid crystal display device, comprising a liquid crystal panel and a backlight module arranged under the liquid crystal panel;
wherein the liquid crystal panel comprises a first substrate and a second substrate respectively arranged on upper and lower sides and opposite to each other, a liquid crystal layer arranged between the first substrate and the second substrate, and a third substrate arranged on a side of the first substrate that is distant from the liquid crystal layer or a side of the second substrate that is distant from the liquid crystal layer;
the first substrate comprises a first backing plate and an upper polarizer arranged on the first backing plate;
the second substrate comprises a second backing plate and a lower polarizer arranged on the second backing plate; and
the third substrate comprises a third backing plate and a quantum dot color filter plate arranged on the third backing plate;
wherein the third substrate further comprises an optic film layer arranged on the quantum dot color filter plate and providing a function of wave filtration; and
wherein the first backing plate, the second backing plate, and the third backing plate each comprise a glass plate, a polyimide (PI) plate, or a polyethylene terephthalate (PET) plate.

12. The liquid crystal display device as claimed in claim 11, wherein the third substrate is arranged on the side of the first substrate that is distant from the liquid crystal layer;
the third substrate further comprises an encapsulation layer arranged on the optic film layer; and
the third backing plate, the quantum dot color filter plate, the optic film layer, and the encapsulation layer of the third substrate are arranged, in sequence, on the side of the first substrate that is distant from the liquid crystal layer.

13. The liquid crystal display device as claimed in claim 11, wherein the third substrate arranged on the side of the second substrate that is distant from the liquid crystal layer; and
the optic film layer, the quantum dot color filter plate, and the third backing plate of the third substrate are arranged, in sequence, on the side of the second substrate that is distant from the liquid crystal layer.

14. The liquid crystal display device as claimed in claim 11, wherein the third substrate is attached to the side of the first substrate that is distant from the liquid crystal layer by coating adhesive on a circumferential edge or an entire surface of the first substrate; or, alternatively,
the third substrate is attached to the side of the second substrate that is distant from the liquid crystal layer by coating adhesive on a circumferential edge or an entire surface of the second substrate.

15. The liquid crystal display device as claimed in claim 11, wherein the upper polarizer is arranged on a side of the first backing plate that is distant from or adjacent to the liquid crystal layer; and
the lower polarizer is arranged on a side of the second backing plate that is distant from or adjacent to the liquid crystal layer.

16. The liquid crystal display device as claimed in claim 11, wherein the quantum dot color filter plate comprises a pixel separation layer and a red pixel unit, a green pixel unit, and a blue pixel unit that are separated from each other by the pixel separation layer.

17. The liquid crystal display device as claimed in claim 16, wherein the backlight module comprises a blue fluorescent light source and the red pixel unit and the green pixel unit are respectively formed of a red quantum dot ink material and a green quantum dot ink material through inkjet printing and the blue pixel unit is formed of a material comprising a transparent organic material.

18. The liquid crystal display device as claimed in claim 17, wherein the optic film layer is formed through patterning and functions to remove blue fluorescent light that emits from the backlight module and is not converted after transmission through the red pixel unit and the green pixel unit.
